(19) United States
(12) Patent Application Publication
(10) Pub. No.: US 2025/0142427 A1
(43) Pub. Date: May 1, 2025

(54) CONFIGURATION AND MANAGEMENT OF CELLS FOR L1/L2 MOBILITY

(71) Applicant: InterDigital Patent Holdings, Inc., Wilmington, DE (US)

(72) Inventors: Martino Freda, Laval (CA); Oumer Teyeb, Montreal (CA); Moon IL Lee, Melville, NY (US); Paul Marinier, Brossard (CA); Keiichi Kubota, Setagaya-Ku (JP); Brian Martin, Farnham (GB)

(73) Assignee: InterDigital Patent Holdings, Inc., Wilmington, DE (US)

(21) Appl. No.: 18/834,010

(22) PCT Filed: Feb. 9, 2023
(86) PCT No.: PCT/US2023/062286

§ 371 Date: Jul. 29, 2024

Related U.S. Application Data
(60) Provisional application No. 63/309,231, filed on Feb. 11, 2022.
(60) Provisional application No. 63/394,778, filed on Aug. 3, 2022.

(51) Int. Cl. H04W 36/00; H04W 76/20; H04W 76/30

(52) U.S. Cl. CPC H04W 36/00835; H04W 36/0058; H04W 76/20; H04W 76/30

(57) ABSTRACT

A wireless transmit/receive unit (WTRU) may be configured to implement layer 1/layer 2 (L1/L2) based inter-cell mobility procedures with reduced latency during handover or other mobility operations. The WTRU may be configured to receive configuration information associated with a plurality of candidate cells. The configuration information may be associated with a physical layer measurement for each candidate cell. The configuration information may include a measurement criteria. The WTRU may be configured to determine a subset of the plurality of candidate cells, with each candidate cell in the subset determined based on the measurement criteria. The WTRU may be configured to send a report indicating the subset. perform a physical layer measurement on the subset, and receive an indication to perform layer handover to a candidate cell of the subset.

### CROSS REFERENCE TO RELATED APPLICATIONS

This application claims the benefit of U.S. Provisional Patent Application No. 63/309,231, filed Feb. 11, 2022, and U.S. Provisional Patent Application No. 63/394,778, filed Aug. 3, 2022, which are hereby incorporated by reference in their entireties.

### BACKGROUND

Users of mobile networks expect quick response times. When a user enters a network, transitions from one network to another network, or opens an application, for example, users may expect operations to occur quickly and/or transparently. Users may become less tolerant of network delays or drops-outs. Additionally, the amount of data being processed by networks continues to increase. Using traditional networks to handle the increased data throughput, delays and drop-outs may be likely to occur.

### SUMMARY

A wireless transmit/receive unit (WTRU) may be configured to implement layer 1/layer 2 (L1/L2)-based inter-cell mobility procedures with reduced latency, during, for example, handover or other mobility operations. For example, a WTRU may be configured to implement inter-cell mobility procedures that utilize one or more mobility procedures designed to reduce latency during a mobility event.

For example, a WTRU may be configured to maintain configurations for multiple candidate cells to allow fast application of the configurations for candidate cells when a mobility procedure is initiated. The WTRU may use dynamic switching mechanism(s) among candidate serving cells (e.g., primary cells (PCell, SpCell) and/or secondary cells (SCells) based on L1 (e.g., physical layer) and/or L2 (e.g., medium access control (MAC), radio link control (RLC), packet data convergence protocol (PDCP), and/or radio resource control (RRC)) signaling. The WTRU may implement physical layer-based techniques for inter-cell beam management, including physical layer/layer 1 (PHY/L1) measurement reporting and beam indication signaling. During or after a mobility event, the WTRU may implement timing advance procedures that reduce latency associated with obtaining timing synchronization. The WTRU and/or network may utilize centralized unit (CU)-distributed unit (DU) interface signaling (e.g., at the gNodeB (gNB) to support WTRU mobility.

A WTRU may receive configuration information associated with one or more candidate cells. The configuration information may be associated with one or more physical layer measurements for one or more candidate cells. For example, a WTRU may receive a set of RRC configurations for candidate cells for L1/L2 mobility. The WTRU may perform beam measurements on a subset of the candidate cells. When the WTRU undergoes a mobility event, the WTRU may indicate to the network the identity of the subset of candidate cells on which it is performing beam measurements.

To support lower layer (L1/L2) mobility, the WTRU may receive a set of RRC configurations for a group of neighbor cell candidates for a given (e.g., current) serving cell. Each RRC configuration may apply to one of the neighbor cells or multiple of the neighbor cells. The WTRU may be configured by RRC with a measurement criteria for one or more (e.g., or each) of the candidates cell. For example, the measurement criteria may include a reference signal received power (RSRP) threshold associated with the candidate cell. The WTRU may be configured with a defined transition time period, which may be configured for a group of neighbor cells or a specific neighbor cell.

The WTRU may apply an RRC configuration and activate neighbor beam management for a subset configured the candidate cells. When applying the RRC configuration, the WTRU may perform a neighbor beam management procedure. The neighbor cell beam management procedure may include performing and/or reporting beam measurements associated with the subset of neighbor cells without triggering a beam failure detection procedure.

The WTRU may determine the subset of candidate serving cells for neighbor cell beam management. In some scenarios, the WTRU may determine the subset of candidate cells (e.g., serving cells) based on the configured measurement criteria, WTRU capabilities, and/or the number of configured serving cells being utilized by the WTRU. For example, the subset of candidate cells (e.g., neighbor cells) may be selected to be all candidate cells that are determined to have RSRP above a threshold, for example assuming the number of candidates that meet the criteria do not exceed the processing capabilities of the WTRU. In some examples, the criteria may include a reference signal received power (RSRP). For example, the criteria may include the RSRP exceeding a threshold. The subset of the plurality of candidate cells may include all candidate cells above the RSRP threshold. The measurement criteria may include channel state information-reference signal received power (CSI-RSRP). In some examples, determining the subset of a plurality of candidate cells may be at least partially based on a number of configured candidate cells. For example, the number of configured candidate cells may be greater than a threshold.

The WTRU may be configured to report to the network the identity of the subset of candidate cells. For example, upon a change of the subset (e.g., due to RSRP change or a mobility event), the WTRU may report the new subset to the network. In an example, the reporting may be by MAC CE or by triggering beam measurement report that indicates the subset. In some scenarios, the report may include a bitmap. The bitmap may be in a MAC CE. The indication to perform handover may be received in downlink control information (DCI). The report may be sent to a base station, for example. The WTRU may report to a network upon a change to one or more of the candidate cells among the subset of a plurality of candidate cells, in some examples.

The WTRU may be configured to perform one or more physical layer measurements on the subset of a plurality of candidate cells. In some scenarios, the WTRU may be configured to perform the one or more measurements on one or more of the candidate cells. In some examples, a physical layer measurement may be one or more of a radio link monitoring measurement or a beam measurement. The WTRU may be configured to receive an indication to perform a handover. The handover may be a lower layer handover in some examples. The handover may be performed to one or more candidate cells of the subset of the plurality of candidate cells, for example. In some scenarios, a candidate cell may be maintained as a candidate cell in the plurality of candidate cells for a predetermined period. The predetermined period may be measured from receipt of the indication to perform handover. In some examples, handover may be initiated after one or more of a beam failure or a failed beam failure recovery.

The WTRU may be configured to switch beams utilized for transmission and/or reception. Upon receiving and/or performing a beam switch from a beam in first cell (e.g., a current serving cell) to a beam of a second cell (e.g., a non-serving cell), the WTRU may change the serving cell to the second cell associated with the new beam. The WTRU may remove the second cell from the subset of candidate cells, for example. The WTRU may add the first cell (e.g., the old serving cell) to the subset of candidate cells. For example, the WTRU may add the first cell to the subset of candidate cells for at least a configured period of time period associated with a configured transition timer. The WTRU may release the configuration of any candidate cells not in subset. For example, the WTRU may release the configuration of any candidate cells not in the subset after performing the beam switch. In some scenarios, the WTRU may be configured to determine a target configuration. The target configuration may be, for example, based at least partially on one or more anchor cell identities. Anchor cell identification may be used for applying a candidate cell configuration, for example.

An example method for implementing L1/L2 mobility may comprise configuring a WTRU with a set of radio resource control (RRC) configurations for each of a group of neighbor cell candidates that neighbor a serving cell, wherein each configuration of the set of configurations comprises a measurement criteria and a transition time period. The WTRU may apply an RRC configuration for each of a subset of the group of neighbor cell candidates and activate neighbor beam management for each of the subset of the group of neighbor cell candidates; report to a network the subset of the group of neighbor cell candidates; receive a beam switch on a cell indicating a beam of a non-serving cell; upon receiving the beam switch, change a current serving cell to a new serving cell, wherein the new serving cell it the non-serving cell for which the beam switch was received; remove the new serving cell from the subset of the group of neighbor cell candidates; add the former current serving cell to the subset of the group of neighbor cell candidates; and release a RRC configuration of any candidate cells not in the subset of the group of neighbor cell candidates.

A WTRU may be configured to receive configuration information. The configuration information may be associated with a plurality of candidate cells. The configuration information may include configuration information associated with a physical layer measurement. The physical layer measurement may be for each candidate cell. Additionally or alternatively, the configuration information may include one or more measurement criteria.

The WTRU may be configured to determine a subset of the plurality of candidate cells. For example, each candidate cell in the subset of the plurality of candidate cells may be determined based on the measurement criteria. The plurality of candidate cells may include all candidate cells above a reference signal received power (RSRP) threshold. Additionally or alternatively, the WTRU may be configured to send a report. The report may indicate the subset of the plurality of candidate cells. The report indicating a subset of the plurality of candidate cells may include a bitmap. The report may be sent via a medium access control (MAC) control element (CE). The report may be sent to a base station.

The WTRU may be configured to perform a physical layer measurement on the subset of the plurality of candidate cells. The WTRU may be configured to receive an indication. The indication may be to perform lower layer handover. The lower layer handover may be to a candidate cell. The candidate cell may be of the subset of the plurality of candidate cells. The indication may be received via a MAC CE. Additionally or alternatively, the indication may be received via downlink control information (DCI).

The physical layer measurement may include a radio link monitoring (RLM) measurement. Additionally or alternatively, the physical layer measurement may include a beam measurement. The measurement criteria may include a reference signal received power. For example, the measurement criteria may include a reference signal received power exceeding a threshold.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an illustrates an example associated with mobility speed and WTRU complexity.

### DETAILED DESCRIPTION

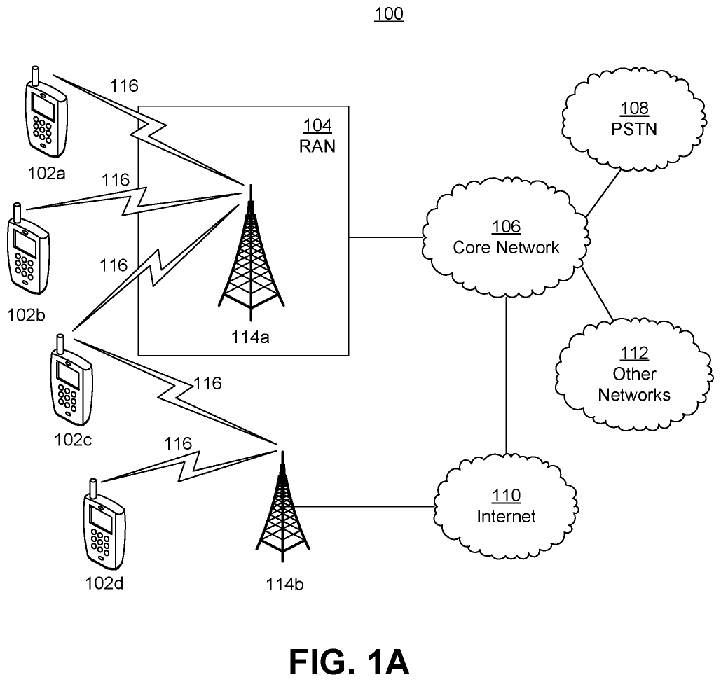

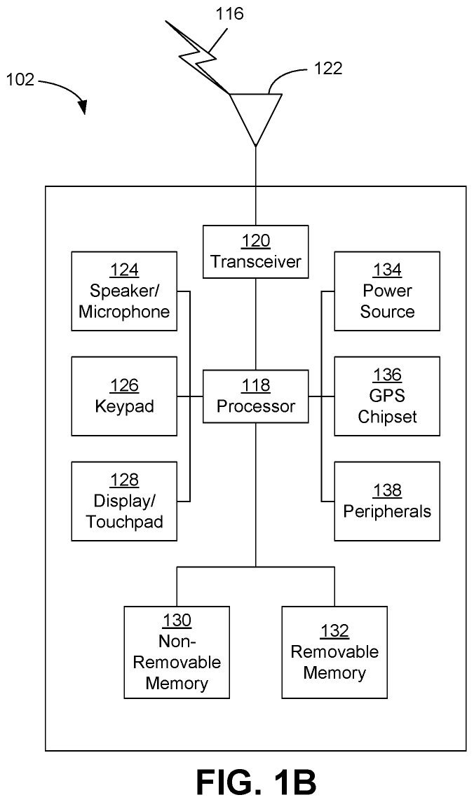

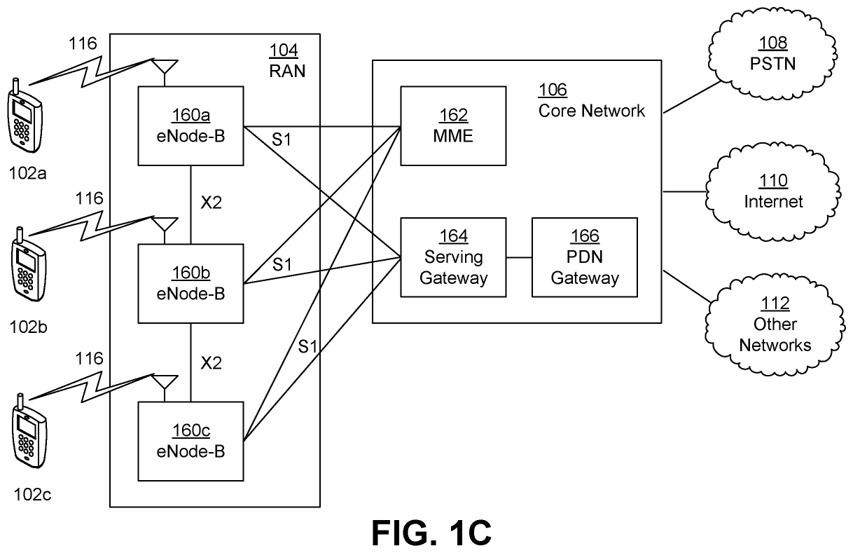

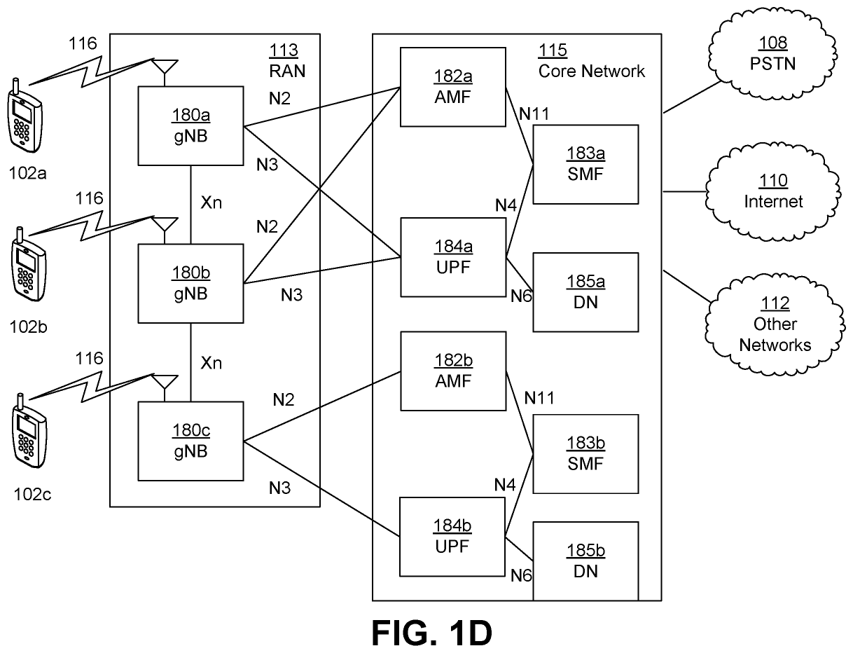

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WTRU may transmit and/or receive a physical channel and/or reference signal. The physical channel and/or reference signal may be transmitted and/or received according to at least one spatial domain filter. The term “beam” may be used to refer to a spatial domain filter. Herein, the terms spatial filter and tx beams may be used interchangeably.

The WTRU may transmit a physical channel and/or signal using a spatial domain filter (e.g., the same spatial filter as the spatial domain filter used for receiving a reference signal (RS)). For example, the RS may include a channel state information reference signal (CSI-RS) and/or a synchronized signal (SS) block. The WTRU transmission may be referred to as “target”. The received RS or SS block may be referred to as “reference” or “source”. In some scenarios, the WTRU may transmit the target physical channel or signal according to a spatial relation with a reference to such RS or SS block.

The WTRU may transmit a first physical channel and/or signal according to a spatial domain filter (e.g., the same spatial domain filter as the spatial domain filter used for transmitting a second physical channel and/or signal). First transmissions may be referred to as “target” or “source”. Second transmissions may be referred to as “reference”. In some examples, the WTRU may be said to transmit the first (e.g., target) physical channel and/or signal according to a spatial relation with a reference to the second (e.g., reference) physical channel and/or signal.

A spatial relation may be implicit. The spatial relation may be configured by RRC and/or signaled by MAC CE and/or DCI. For example, a WTRU may implicitly transmit physical uplink shared channel (PUSCH) and/or demodulation reference signal (DM-RS) of PUSCH. For example, the transmission may be transmitted according to a spatial domain filter (e.g., the same spatial domain filter as a sounding reference signal (SRS). The SRS may be indicated by an SRS resource indicator (SRI) and/or indicated in DCI and/or configured by RRC. In another example, a spatial relation may be configured by RRC for SRI and/or signaled by MAC CE for a PUCCH. Such spatial relation may also be referred to as a “beam indication”.

The WTRU may receive a first (e.g., target) downlink channel and/or signal. For example, the WTRU may receive the first downlink channel according to a spatial domain filter (e.g., the same spatial domain filter) and/or spatial reception parameter as a second (e.g., reference) downlink channel and/or signal. For example, an association may exist between a physical channel such as PDCCH or PDSCH and/or respective DM-RS. The first and second signals may reference signals. In some scenarios, the WTRU may receive a first (e.g., target) downlink channel and/or signal according to the same spatial domain filter and/or spatial reception parameter as a second (e.g., reference) downlink channel and/or signal when the WTRU is configured with a quasi-colocation (QCL) assumption type D between corresponding antenna ports. The association may be configured as a TCI (transmission configuration indicator) state. A WTRU may be indicated by an association between a CSI-RS and/or SS block and a DM-RS. This association may be, for example, based on an index. The index may be to a set of TCI states configured by RRC and/or signaled by MAC CE. Such indication may also be referred to as a “beam indication”.

In a beamformed system, for example, the WTRU may be configured to maintain one or multiple beam pairs. In some scenarios, the WTRU may monitor periodic CSI-RS (e.g., certain periodic CSI-RS). The WTRU may monitor periodic CSI-RS to assess its quality and/or compute a corresponding quality metric. For example, the WTRU may monitor periodic CSI-RS on a serving DL beam. The WTRU's PHY entity may report a beam failure instance (BFI). The beam failure instance may be reported to the MAC sub-layer. For example, if the beam quality in a given RS period for one or more beams (e.g., all beams) in a maintenance set is below a configured threshold, the WTRU's PHY entity reports a BFI.

The WTRU may maintain a beam failure detection (BFD) procedure. The BFD procedure may include periodic measurement of maintained beams and/or a beam failure recovery (BFR) request. The BFR request may be reported to the network upon detecting a beam failure. The BFR may be configured for beam maintenance on the PCell and/or SCell, for example. In some examples, when BFD and/or discontinuous reception (DRX) are configured, BFD measurements may be taken. The BFD measurements may be taken at the max of a DRX period and/or CSI-RS period. The WTRU may maintain a BFD procedure in order to reestablish lost beam pair(s). The reestablishment of lost beam pair(s) may be faster than an RLM/RLF procedure.

The MAC entity may maintain a beam failure instance (BFI) counter. The BFI counter may be used for beam failure detection. In some scenarios, the MAC entity may count the number of beam failure instance indications. The number of beam failure instance indications may be received from the PHY entity, for example. The BFI counter may exceed a certain maximum number of BFIs. A BFR request may be triggered to notify the serving gNB that a beam failure has been detected. The BFR request may be triggered when the BFI counter exceeds a certain maximum number of BFIs.

In some scenarios, the MAC entity may reset the BFI counter. The MAC entity may reset the BFI counter after a beam failure detection timer (BFD timer) has expired. This may help provide, for example, some hysteresis in the detection function. In some examples, the WTRU may reset the BFD timer each time a BFI is indicated. For example, the MAC entity may reset the BFI counter after observing no BFI indications from PHY for a number (e.g., three) of consecutive CSI-RS periods if, for example, the BFD timer is configured to the number (e.g., three) of CSI-RS periods.

In some scenarios, the WTRU may initiate a random access procedure for beam re-establishment. The WTRU may initiate the random access procedure, for example, to report a BFR request for a beam failure detected for the SpCell. The WTRU may select an appropriate PRACH preamble and/or PRACH resource. The selection may be based on the best measured downlink beam (e.g., CSI-RS and/or DL synchronization signal block (SSB)). The WTRU may be configured to reestablish a beam pair. The WTRU may be configured to reestablish the beam pair when a determination is made that there is an association between DL beams and/or UL preambles and/or PRACH occasions. The downlink beam selected by the WTRU may be tested by receiving the random access response (RAR). A reestablishment random access (RA) procedure may be made faster if the gNB configures a set of contention-free PRACH preambles/resources. For example, the contention-free PRACH preambles/resources maybe prioritized for selection by the WTRU. The prioritization may be upon initiating the RA procedure. In some scenarios, the WTRU may transmit a MAC CE indicating the cell on which beam failure was detected. The WTRU may transmit the MAC CE to report a BFR request for a beam failure detected for the Scell,

In some scenarios, a mechanism and/or a procedure of L1/L2 based inter-cell mobility may reduce latency. For example, a configuration and/or maintenance for multiple candidate cells may allow for fast applications of configurations for candidate cells (e.g., RAN2, RAN3). A dynamic switch mechanism between candidate serving cells (e.g., SpCell(s) and/or SCell(s)) may be applicable based on L1/L2 signaling (e.g., Ran2, RAN1). In some scenarios, L1 enhancements for inter-cell beam management may include one or more of L1 measurement and/or reporting, and beam indication (e.g., RAN1, RAN2). For example, RAN2 may be used for inter-cell beam management and/or beam indication. In some scenarios, there may be timing advance management (e.g., RAN1, RAN2). There may be centralized unit-distributed unit (CU-DU) interface signaling for L1/L2 mobility support (e.g., RAN3). In some examples, beam switching techniques may be used for L1/L2 mobility to change cells using beam mobility techniques as herein.

A WTRU may be configured to perform Layer 1/PHY and/or Layer 2/MAC/RLC/PDCP/RRC mobility procedures. Certain handover commands may include cell configurations. For example, the cell configurations may include a target cell configuration which may, for example, be indicated as a delta configuration on a source cell configuration. L1/L2 mobility as described herein, may refer to a WTRU that is configured to perform mobility (e.g., frequent mobility without significant signaling overhead). The WTRU may be provided with the cell configurations of one or more (e.g., multiple) cells available at the WTRU. For example, the configuration may not be provided to the WTRU in full (e.g., the confirmation may reference a cell as a delta configuration). The WTRU may store radio resource control (RRC) configurations of each cell. The WTRU may apply that RRC configuration, and/or indicate that the cell is in a deactivated state. For example, indicating that a cell is in the deactivated state, may allow the WTRU to perform beam measurements on beams associated with non-serving cells, which may be used (e.g., by the network) to trigger L1/L2 mobility. The WTRU may be configured to switch beams utilized for transmission and/or reception. For example, upon receiving and/or performing a beam switch from a beam in first cell (e.g., a current serving cell) to a beam of a second cell (e.g., a non-serving cell), the WTRU may change its serving cell to the second cell associated with the new beam. The WTRU may remove the second cell from the subset of candidate cells. The WTRU may add the first cell (e.g., the old serving cell) to the subset of candidate cells. For example, the WTRU may add the first cell to the subset of candidate cells for at least a configured period of time period associated with a configured transition timer. The WTRU may release the configuration of any candidate cells not in subset. For example, the WTRU may release the configuration of any candidate cells not in the subset after performing the beam switch. In some embodiments, the WTRU may be configured to determine a target configuration. The target configuration may be, for example, based at least partially on one or more anchor cell identities. Anchor cell identifications may be used for applying a candidate cell configuration, for example.

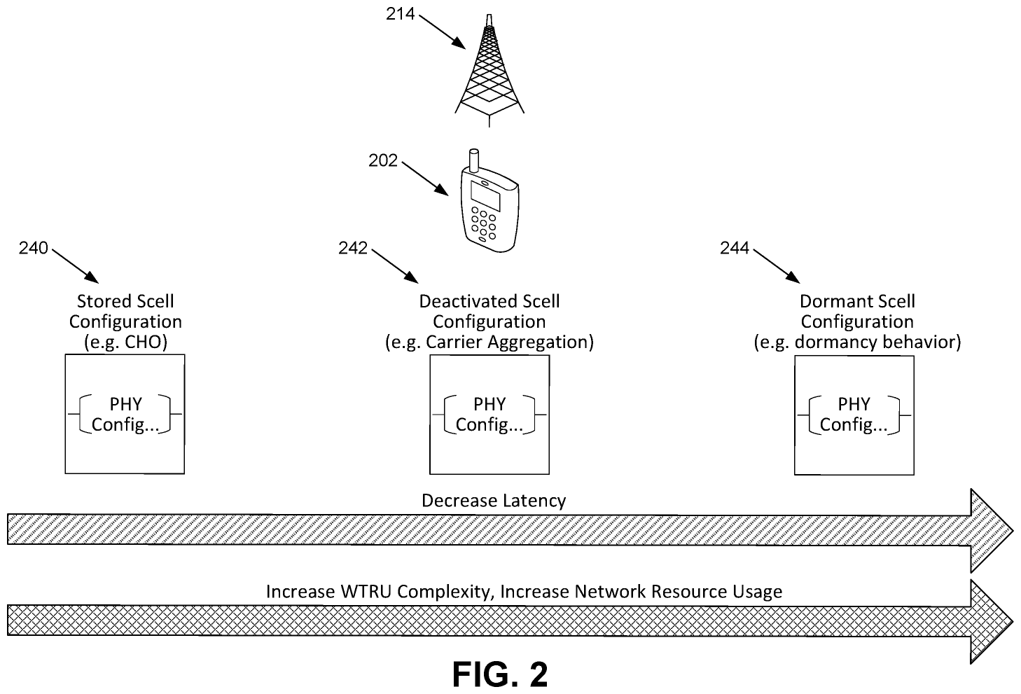

FIG. 2 illustrates an example associated with mobility speed and WTRU complexity. The example illustrated in FIG. 2 may consider the different modelings of a cell configuration at a WTRU 202 in, for example, a new radio (NR) network. The network may include a base station 214. In some scenarios, there may be multiple WTRUs 102 and/or multiple base stations 214, as described herein. As the complexity of the WTRU 202 and the number of network resources increase, the latency associated with L1/L2 operations may decrease. For example, a dormant Scell configuration 244 (e.g., dormancy behavior) has a lower latency than both a deactivated Scell configuration 242 (e.g., carrier aggregation) and a stored cell configuration 240 (e.g., CHO). FIG. 2 also illustrates that the deactivated Scell configuration 242 (e.g., carrier aggregation) has a lower latency than the stored cell configuration 240 (e.g., CHO).

FIG. 2 illustrates that a dormant Scell configuration 244 (e.g., dormancy behavior) has a higher WTRU complexity and network resource usage than both a deactivated Scell configuration 242 (e.g., carrier aggregation) and a stored cell configuration 240 (e.g., CHO). The deactivated Scell configuration 242 (e.g., carrier aggregation) also has a higher WTRU complexity and network resource usage than the stored cell configuration 240 (e.g., CHO).

A WTRU may be configured to perform conditional handover (CHO) and conditional primary Scell (PSCell) addition/change CPA/CPC in NR radio networks. For example, L1/L2 mobility as described herein may implement conditional handover and/or conditional PSCell addition/change. For example, in conditional handover (CHO) a WTRU may be configured (e.g, via an RRC reconfiguration message) with a HO target (e.g., a target cell configuration) and an associated condition in terms of a cell measurement event (e.g., event A3/A5, and corresponding cells). A WTRU may initiate monitoring of the associated condition. For example, the WTRU may initiate monitoring of the associated condition following configuration by reception of the CHO command. When the condition is satisfied, the WTRU may trigger a HO (reconfiguration) to the associated cell with the given configuration. For conditional PSCell change (CPC) and/or conditional PSCell addition (CPA), a WTRU may trigger a PSCell change, or PSCell addition, associated with a stored PSCell configuration. For example, for conditional PSCell change (CPC) and/or conditional PSCell addition (CPA), a WTRU may trigger a PSCell change, or PSCell addition, associated with a stored PSCell configuration upon triggering of an associated condition defined by a measurement event.

A wireless transmit/receive unit (WTRU) may be configured to implement layer 1/layer 2 (L1/L2)-based inter-cell mobility procedures with reduced latency, during, for example, handover or other mobility operations. For example, a WTRU may be configured to implement inter-cell mobility procedures that utilize one or more mobility procedures designed to reduce latency during a mobility event.

For example, a WTRU may be configured to maintain configurations for multiple candidate cells to allow fast application of the configurations for candidate cells when a mobility procedure is initiated. The WTRU may use dynamic switching mechanism(s) among candidate serving cells (e.g., primary cells (PCell, SpCell) and/or secondary cells (SCells)) based on L1 (e.g., physical layer) and/or L2 (e.g., medium access control (MAC), radio link control (RLC), packet data convergence protocol (PDCP), and/or radio resource control (RRC)) signaling. The WTRU may implement physical layer-based techniques for inter-cell beam management, including physical layer/layer 1 (PHY/L1) measurement reporting and beam indication signaling. During or after a mobility event, the WTRU may implement timing advance procedures that reduce latency associated with obtaining timing synchronization. The WTRU and/or network may utilize centralized unit (CU)-distributed unit (DU) interface signaling (e.g., at the gNodeB (gNB)) to support WTRU mobility.

A WTRU may receive configuration information associated with one or more candidate cells. The configuration information may be associated with one or more physical layer measurements for one or more candidate cells. For example, a WTRU may receive a set of RRC configurations for candidate cells for L1/L2 mobility. The WTRU may perform beam measurements on a subset of the candidate cells. When the WTRU undergoes a mobility event, the WTRU may indicate to the network the identity of the subset of candidate cells on which it is performing beam measurements.

To support lower layer (L1/L2) mobility, the WTRU may receive a set of RRC configurations for a group of neighbor cell candidates for a given (e.g., current) serving cell. Each RRC configuration may apply to one of the neighbor cells or multiple of the neighbor cells. The WTRU may be configured by RRC with a measurement criteria for one or more (e.g., or each) of the candidates cell. For example, the measurement criteria may include a reference signal received power (RSRP) threshold associated with the candidate cell. The WTRU may be configured with a defined transition time period, which may be configured for a group of neighbor cells or a specific neighbor cell.

The WTRU may apply an RRC configuration and activate neighbor beam management for a subset configured the candidate cells. When applying the RRC configuration, the WTRU may perform a neighbor beam management procedure. The neighbor cell beam management procedure may include performing and/or reporting beam measurements associated with the subset of neighbor cells without triggering a beam failure detection procedure.

The WTRU may determine the subset of candidate serving cells for neighbor cell beam management. In some scenarios, the WTRU may determine the subset of candidate cells (e.g., serving cells) based on the configured measurement criteria, WTRU capabilities, and/or the number of configured serving cells being utilized by the WTRU. For example, the subset of candidate cells (e.g., neighbor cells) may be selected to be all candidate cells that are determined to have RSRP above a threshold, for example assuming the number of candidates that meet the criteria do not exceed the processing capabilities of the WTRU. In some examples, the criteria may include a reference signal received power (RSRP). For example, the criteria may include the RSRP exceeding a threshold. The subset of the plurality of candidate cells may include all candidate cells above the RSRP threshold. The measurement criteria may include channel state information-reference signal received power (CSI-RSRP). In some examples, determining the subset of a plurality of candidate cells may be at least partially based on a number of configured candidate cells. For example, the number of configured candidate cells may be greater than a threshold.

The WTRU may be configured to report to the network the identity of the subset of candidate cells. For example, upon a change of the subset (e.g., due to RSRP change or a mobility event), the WTRU may report the new subset to the network. In an example, the reporting may be by MAC CE or by triggering beam measurement report that indicates the subset. In some scenarios, the report may include a bitmap. The bitmap may be in a MAC CE. The indication to perform handover may be received in downlink control information (DCI). The report may be sent to a base station, for example. The WTRU may report to a network upon a change to one or more of the candidate cells among the subset of a plurality of candidate cells, in some examples.

The WTRU may be configured to perform one or more physical layer measurements on the subset of a plurality of candidate cells. In some scenarios, the WTRU may be configured to perform the one or more measurements on one or more of the candidate cells. In some examples, a physical layer measurement may be one or more of a radio link monitoring measurement or a beam measurement. The WTRU may be configured to receive an indication to perform a handover. The handover may be a lower layer handover in some examples. The handover may be performed to one or more candidate cells of the subset of the plurality of candidate cells, for example. In some scenarios, a candidate cell may be maintained as a candidate cell in the plurality of candidate cells for a predetermined period. The predetermined period may be measured from receipt of the indication to perform handover. In some examples, handover may be initiated after one or more of a beam failure or a failed beam failure recovery.

The WTRU may be configured to switch beams utilized for transmission and/or reception. Upon receiving and/or performing a beam switch from a beam in first cell (e.g., a current serving cell) to a beam of a second cell (e.g., a non-serving cell), the WTRU may change the serving cell to the second cell associated with the new beam. The WTRU may remove the second cell from the subset of candidate cells, for example. The WTRU may add the first cell (e.g., the old serving cell) to the subset of candidate cells. For example, the WTRU may add the first cell to the subset of candidate cells for at least a configured period of time period associated with a configured transition timer. The WTRU may release the configuration of any candidate cells not in subset. For example, the WTRU may release the configuration of any candidate cells not in the subset after performing the beam switch. In some scenarios, the WTRU may be configured to determine a target configuration. The target configuration may be, for example, based at least partially on one or more anchor cell identities. Anchor cell identification may be used for applying a candidate cell configuration, for example.

An example method for implementing L1/L2 mobility may comprise configuring a WTRU with a set of radio resource control (RRC) configurations for each of a group of neighbor cell candidates that neighbor a serving cell, wherein each configuration of the set of configurations comprises a measurement criteria and a transition time period. The WTRU may apply an RRC configuration for each of a subset of the group of neighbor cell candidates and activate neighbor beam management for each of the subset of the group of neighbor cell candidates; report to a network the subset of the group of neighbor cell candidates; receive a beam switch on a cell indicating a beam of a non-serving cell; upon receiving the beam switch, change a current serving cell to a new serving cell, wherein the new serving cell it the non-serving cell for which the beam switch was received; remove the new serving cell from the subset of the group of neighbor cell candidates; add the former current serving cell to the subset of the group of neighbor cell candidates; and release a RRC configuration of any candidate cells not in the subset of the group of neighbor cell candidates.

A WTRU may be configured to receive configuration information. The configuration information may be associated with a plurality of candidate cells. The configuration information may include configuration information associated with a physical layer measurement. The physical layer measurement may be for each candidate cell. Additionally or alternatively, the configuration information may include one or more measurement criteria.

The WTRU may be configured to determine a subset of the plurality of candidate cells. For example, each candidate cell in the subset of the plurality of candidate cells may be determined based on the measurement criteria. The plurality of candidate cells may include all candidate cells above a reference signal received power (RSRP) threshold. Additionally or alternatively, the WTRU may be configured to send a report. The report may indicate the subset of the plurality of candidate cells. The report indicating a subset of the plurality of candidate cells may include a bitmap. The report may be sent via a medium access control (MAC) control element (CE). The report may be sent to a base station.

The WTRU may be configured to perform a physical layer measurement on the subset of the plurality of candidate cells. The WTRU may be configured to receive an indication. The indication may be to perform lower layer handover. The lower layer handover may be to a candidate cell. The candidate cell may be of the subset of the plurality of candidate cells. The indication may be received via a MAC CE. Additionally or alternatively, the indication may be received via downlink control information (DCI).

The physical layer measurement may include a radio link monitoring (RLM) measurement. Additionally or alternatively, the physical layer measurement may include a beam measurement. The measurement criteria may include a reference signal received power. For example, the measurement criteria may include a reference signal received power exceeding a threshold.

A WTRU may be configured to implement MAC and/or RRC Layer procedures to support L1/L2 Mobility.

As described herein, the term SCell may refer to a serving cell, which may include a primary cell (PCell), a primary cell of secondary cells (PSCell), and/or a secondary cell (sCell) (e.g., in carrier aggregation). The architecture for L1/L2 mobility may comprise a WTRU configured with stored configurations associated with one or more cells (e.g., candidate cells). For example, the stored cell configurations may be specific to (e.g., or associated with) a (e.g., one) PSCell and/or an (e.g., one) SCell. In certain scenarios, a common set of candidate cells may be associated with multiple cells (e.g., possibly including the SpCell). A candidate cell may be configured with an association (e.g., reference) to a subset of the SCells (e.g., possibly including the SpCell). An SCell may also, or alternatively, be configured with an association (e.g., reference) to a subset of the candidate cells. For example, multiple SCells may have an association to the same candidate cell.

The WTRU may identify or determine a subset of the cells within the set of candidate cells as potential L1/L2 mobility target (PLMT) cells (e.g., a list of PLMT cells). The list of PLMT cells may also be referred to as the set of PLMT cells herein. For example, the list of PLMT cells for a given set of candidate cells may be configured by the network. The WTRU may update (e.g., add and/or remove) the cells in the list of PLMT cells. For example, a WTRU may add a candidate cell to the list of PLMT cells based on rules defined herein. In some scenarios, a PLMT cell may be removed from the list of PLMT cells. The removed PLMT cell may remain a candidate cell. A WTRU may receive configuration information associated with one or more candidate cells. The configuration information may be associated with one or more physical layer measurements (e.g., RLM, beam measurements, SSB, and/or CSI-RS) for one or more candidate cells.

L1/L2 mobility may be performed by receiving signaling (e.g., beam change, transmission configuration indicator (TCI) state change, etc.) via L1/L2 signaling. For example, L1/L2 mobility signaling may be performed via downlink control information (DCI), or a medium access control (MAC) control element (CE). The L1/L2 mobility signaling may, for example, be used to update the current service cell to a PLMT cell. For example, the network may signal a beam switch to a beam associated with a non-serving PLMT cell. Upon reception of such signaling, the WTRU may perform a serving cell change from the serving cell to the PLMT cell for which the WTRU has already applied and validated the RRC configuration.

As described herein, the term SCell may be used to refer to a serving cell, which may be a PCell, PSCell, or SCell (e.g., secondary cell in carrier aggregation).

A WTRU may be configured to implement certain behavior for deactivated and dormant SCells, for example to facilitate improved L1/L2 mobility.

A WTRU may be served by a serving cell (e.g., cell A). The WTRU may be provided with an RRC configuration, e.g., via the serving cell. For example, the RRC configuration may be associated with one or more candidate cells B, C, D, etc. The candidate cells and their configurations may be associated with serving cell A. Alternatively, or additionally, the candidate cells may be common to a number of serving cells (e.g., cells C and D may be candidate cells when served by cell A and cell B).

A WTRU may receive one or more candidate cell configurations (e.g., via system information block (SIB) and/or RRC signaling (e.g., dedicated RRC signaling). The WTRU may receive the RRC signaling from a serving cell, for example. In certain scenarios, for example, the WTRU may store the candidate cell configurations without applying (e.g., without immediately applying) the configurations. For example, the WTRU may store the candidate cells and wait a period of time before applying the configurations. The period of time may be based on a threshold. Alternatively, or additionally, a WTRU may receive an indication to apply (e.g., immediately apply) the candidate cell configuration. For example, the indication to apply the candidate cell configuration may be received from the network.

A WTRU that applies a stored candidate cell configuration may behave similar to a WTRU which adds a secondary cell (e.g., in carrier aggregation). In certain examples, the WTRU may treat such a secondary cell as a dormant SCell. For example, the WTRU may treat the secondary cell as a dormant cell after applying the configuration. In some examples, the WTRU may not perform physical downlink control channel (PDCCH) decoding, and/or physical uplink control channel (PUCCH) transmission on the secondary cell. The WTRU may alternatively, or additionally, perform beam management (e.g., on the secondary cell). In certain scenarios, the beam management procedures performed on a candidate cell may, for example, be different than the beam management procedures performed on a secondary cell (e.g., in carrier aggregation (CA)). Performing beam management on a candidate cell may allow the WTRU to report beam measurements. Beam measurement reports may be transmitted to the network (e.g., in association with L1/L2 mobility). A WTRU may start beam measurement reporting based on a TCI state configuration. The TCI state configuration may be associated with the cell provided in RRC configuration from the serving cell. In some examples, the WTRU may start beam measurement reporting following the application of a stored configuration for a candidate cell and/or the addition of the cell as a PLMT cell. The WTRU may remove the cell from being a PLMT cell. The WTRU may stop beam measurement reporting. For example, the WTRU may stop beam measurement reporting for the cells that the WTRU removes from being a PLMT cell. The WTRU may additionally or alternatively release the RRC configuration for the cell (e.g., the cell removed from being a PLMT cell). In some examples, the WTRU may store (e.g., continue to store) the RRC configuration for a cell that is removed from being a PLMT cell, e.g., if the cell remains a candidate cell. Additionally, or alternatively, a WTRU may perform radio link monitoring/radio link failure (RLM/RLF) differently for a cell that is a PLMT cell. For example, a WTRU may use a different configuration associated with RLM/RLF. Additionally, or alternatively, the WTRU may monitor one or more reference symbols (e.g., different reference symbols), use one or more RLF timers (e.g., different RLF timers), use a Qin value (e.g., different Qin value) and/or use a Qout value (e.g., different Qout value).

In some examples, a WTRU may treat a cell as a deactivated SCell. For example, the WTRU may treat a cell as a deactivated cell after applying a configuration to deactivate the cell. In some examples, the WTRU may apply the RRC configuration for the candidate cell, and/or may not perform beam management and/or RLM/RLF for the cell. The WTRU may initiate beam management and/or RLM/RLF for the cell. For example, the WTRU may initiate beam management and/or RLM/RLF for the cell based on signaling received from the network (e.g. via a MAC CE, such as an activation/deactivation MAC CE). If the WTRU initiates beam management and/or RLM/RLF for the cell based on signaling received from the network (e.g., a MAC CE), the WTRU may treat the cell as a dormant SCell (e.g., also referred to as a PLMT cell herein), as described herein. For example, a WTRU may receive a MAC CE that activates or deactivates beam measurement/reporting and/or RLM/RLF for that WTRU (e.g., without initiating any PDCCH monitoring) until the WTRU receives L1/L2 mobility trigger. Also, or alternatively, the WTRU may add (e.g., autonomously add) the cell to the PLMT cell based on any of the techniques described herein. In some examples (e.g., where WTRU autonomously adds the cell to the list of PLMT cells), the WTRU may initiate beam management and measurement reporting to the network.

A WTRU may be configured to implement beam management procedures for PLMT cells.

A WTRU may receive indications associated with TCI state configurations. For example, TCI state configurations may be used for controlling beam management for a set of CSI configurations. One more of the following may apply.

A WTRU may receive a TCI state configuration. For example, the TCI state configuration may be used by the WTRU for controlling beam management for a set of CSI configurations. The TCI state configuration may be configured by a serving cell (e.g., via RRC). In certain scenarios, the TCI state configurations received from a serving cell may to be applied to a CSI configuration applied to a neighbor cell (e.g., the PLMT cells). Such configuration may be different than the CSI configuration applied to the neighbor cell after L1/L2 mobility. For example, the WTRU may switch from a first TCI state configuration to a second TCI state configuration (e.g., in association with L1/L2 mobility).

A WTRU may receive signaling (e.g., a MAC CE) that selects a subset of the TCI states (e.g., configured by RRC) for the PLMT cells and/or for controlling beam measurements. For example, such signaling may be received from the serving cell. A WTRU may, for example, receive signaling (e.g., via DCI) to change the beam being measured on the list of PLMT cells for beam reporting.

A WTRU may deactivate or stop beam measurements on a PLMT cell, for example, based on receiving of a deactivation command. For example, the deactivation command received by the WTRU may be similar to or include a deactivation MAC CE. Following activation, for example, the WTRU may re-initiate beam management, e.g., using a previous (e.g., the last) TCI state selected for that PLMT cell.

A WTRU may be configured to implement a procedure for managing candidate cell configurations. One or more of the following may apply.

A WTRU may be configured with a set of candidate cells, for example, via RRC configurations (e.g., of PHY, MAC, etc.). For example, the RRC configurations may indicate the parameters to be used by the WTRU when operating on the set of candidate cells. A candidate cell or candidate cell list may be associated with one or more SCells (e.g., SCells that may be activated at the WTRU). In certain scenarios, however, a candidate cell may not be an activated/deactivated SCell at the WTRU.

A WTRU, may be with a candidate cell. The WTRU may store the candidate cell configuration, for example, without applying the candidate cell configuration. The WTRU may be configured with rules/events to trigger application of the candidate cell configuration. In addition, or alternatively, a WTRU may be configured with rules/events for when to initiate L1 measurements (e.g., beam measurements) on a candidate cell (e.g., a candidate cell whose configuration has been applied at the WTRU). A similar (e.g., the same) set of rules may, for example, be used to apply a candidate cell RRC configuration at the WTRU, and/or to initiate the L1 measurements. For example, if a configured rule/event triggers a WTRU to apply the RRC configuration, the WTRU may initiate L1 measurements on the cell (e.g., according the L1 configuration). Also, or alternatively, the WTRU may be configured with a first rule/event to apply the RRC configuration, and a second rule/event to initiate L1 measurements. The first rules/event and/or the second rule/event may be based on L3 measurements (e.g., L3 measurements performed by the WTRU on the candidate cells). A WTRU may be configured with the L3 measurements to perform on a candidate cell. A WTRU may perform the L3 measurements. In certain scenarios, the WTRU may perform the L3 measurements and may not report the L3 measurements. A WTRU may, for example, use such measurements as part of the criteria for applying the cell configuration and/or initiating L1 measurements. For example, the WTRU may be configured with a first L3 measurement based event to trigger the application of a candidate cell, and/or a second L3 measurement event to initiate L1 measurements. Alternatively, or additionally, the WTRU may be configured with an L3 measurement based event to trigger application of a candidate cell, and another trigger (e.g. network signaling, positioning trigger, etc. as described herein) to initiate L1 measurements.

In certain scenarios, some RRC parameters/configuration/information elements (IEs) may not be affected by L1/L2 mobility. For example, the WTRU may maintain previously configured parameters/IEs. Additionally or alternatively, the WTRU may apply the non-maintained RRC parameters. In some examples, the WTRU may maintain previously configured parameters upon L1/L2 mobility, and/or apply the non-maintained RRC parameters upon L1/L2 mobility. The RRC configuration of the target L1/L2 mobility may be associated with a set of parameters/IEs that are stored (e.g., remain stored). For example, the set of parameters/IEs may be stored as a PLMT cell and/or at L1/L2 mobility. The parameters/IEs may not be applied in certain scenarios. The parameters/IEs may be stored and/or applied by the WTRU when adding the cell to the list of PLMT cells and/or applying the configuration. For example, the WTRU may, e.g., upon applying the cell configuration or adding the cell as a PLMT cell, apply the RRC configuration. The WTRU may additionally or alternatively apply the RRC configuration except for one or more IEs. The one or more IEs may that are not applied may remain stored, but not applied, for example. In some examples, the WTRU may apply the RRC configuration upon applying the cell configuration and/or adding the cell as a PLMT cell. IEs may be applied at a later time, such as for example, at L3 re-configuration (e.g., L3 mobility and/or L3 re-configuration), and/or a cell changes (e.g., a network controlled anchor cell change). In some examples, one or more of the following may not be applied by the WTRU during the addition of a cell as a PLMT cell: the candidate cell list, the events/conditions related to the candidate cell list, specific cell(s) that are to be (e.g., always) considered PLMT cells for a given anchor or serving cells, and/or any configuration parameters associated with maintenance of candidate cells or PLMT cells. The WTRU may be provided with a RLM/RLF configuration that, in certain scenarios, is to remain unchanged. For example the RLM/RLF configuration may remain unchanged at L1/L2 mobility. Additionally or alternatively, the RLM/RLF configuration may be (e.g., may only be) changed upon L3 handover. The WTRU may receive a condition (e.g., trigger) for performing RLM/RLF on PLMT cells and/or may apply the RLM/RLF configuration upon an L3 handover procedure. As a result, these parameters may be unchanged due to L1/L2 mobility. In some examples, the stored parameters for the cell may be different than the parameters applied to the target cell. For example, the stored parameters for the cell may be different than the parameters applied to the target cell after L1/L2 mobility.

Certain RRC parameters may applied based on the addition of a cell to PLMT list at L1/L2 mobility. An RRC configuration for a candidate cell may be divided into one or more (e.g., two) parts. The parts may include a first part and a second part. For example, the WTRU may apply the first part when the WTRU adds the candidate cell to the PLMT list and/or applies the configuration. The second part may be applied, for example, at L1/L2 mobility. The WTRU may use the candidate cell list. For example, the candidate cell list when the WTRU is served by a cell B may be configured by cell A. The WTRU served by cell A may apply the configuration of cell B (e.g., if cell B is added to the PLMT list). In certain scenarios, the WTRU may, for example, not apply the candidate cell list until L1/L2 mobility is triggered. For example, the WTRU may apply the beam measurement and/or report configuration of a PLMT cell. The WTRU may apply the beam measurement and/or report configuration of a PLMT cell. For example, the WTRU may apply the beam measurement and/or report configuration upon PLMT addition. The WTRU may apply one or more of the PDCCH configurations, PUCCH configuration, data decoding transmission configuration, etc. For example, the WTRU may apply one or more of the PDCCH configuration, PUCCH configuration, data decoding transmission configuration, etc. upon L1/L2 handover. In some examples, the WTRU may maintain the beam measurement and/or report configuration. For example, the WTRU may maintain the beam measurement and/or report configuration when a cell is added to the PLMT list. The WTRU may apply certain parameters for the target cell. For example, the WTRU may apply certain parameters for the target cell in advance of the L1/L2 mobility (e.g., which may avoid RRC re-configuration latency). The WTRU may ensure that some configurations (e.g., the candidate cell list and/or parameters controlling the addition of candidates to the list of PLMT cells) are (e.g., can be) applied across one or more cells (e.g., the serving cell and/or the candidate cells).

A WTRU may request the RRC configuration of a cell (e.g., the candidate cell) from the network (e.g., using an RRC message such as dedicatedSIBRequest or similar). For example, the WTRU may request the RRC configuration in order to avoid storing a large number of cell configurations at the WTRU for mobility, and/or in order to reduce the signaling overhead of providing a large number of candidate cell configurations at each cell for each WTRU. The RRC configuration of the candidate cells to be used in a cell may be stored in a separate system information block (SIB). For example, if the RRC configuration associated with the candidate cells is stored in a separate SIB, the WTRU may use a dedicatedSIBRequest and/or SI request to acquire the system information (SI) (e.g., if the WTRU is unable to receive the SI from a broadcast at a given time). Alternatively, or additionally, a WTRU may request the RRC configuration of one or more candidate cell(s). For example, the WTRU may request (e.g., individually request) the RRC configuration of one or more candidate cell(s) using an RRC message and/or a modified version of a dedicatedSIBRequest. In some examples, a WTRU may request the candidate cell configurations of a subset of the candidate cells. The WTRU may request the candidate cell configurations of a subset of the candidate cells request based on one or more conditions. For example, the WTRU may request the candidate cell configurations of a subset of the candidate cells based on the addition of a candidate cell as a PLMT cell. In some examples, a WTRU may trigger a request to obtain a candidate cell configuration based on one or more of: the measured cell quality being above a threshold, the WTRU's position being within a specified distance of the cell, and/or when one or more trigger for adding a candidate cell as a PLMT cell are also triggers the WTRU to request the configuration of a candidate cell.

In certain scenarios, a candidate cell configuration failure may occur. For example, configuration failure may occur when a WTRU applies a candidate cell RRC configuration. A WTRU may report a candidate cell configuration failure to the network The configuration failure report may be sent immediately (e.g., at the time of configuration failure), at a subsequent event trigger, and/or based on a condition. For example, the condition that triggers the WTRU to send a configuration failure report may be after the configuration failure occurs. In some examples, a WTRU may send/report a candidate cell configuration failure at one or more of the following times: immediately at configuration failure; when the number of configuration failures is greater than a certain threshold; upon a successful/failed L3 mobility procedure; upon a successful/failed L1 mobility procedure; when beam failure is detected on an SCell and/or on a candidate cell; when the number of candidate cells for which L1 measurements are active is below a threshold; when the number of candidate cells for which L1 measurements are not active is below a threshold; when the number of candidate cells that have an applied RRC configuration is below a threshold; when the number of candidate cells that have an applied RRC configuration, but no active L1 measurements, is below a threshold; when the total number of candidate cells which do not have a pending reconfiguration failure (e.g., to be reported) is below a threshold; when a configured number of RRC configuration failures occur; and/or when an alternate candidate cell cannot be found that meets the criteria for adding the candidate cell. In some examples, an alternate candidate cell may not result in configuration failure. Alternatively, or additionally, a WTRU may report a configuration failure when a configured number of RRC configuration failures occur.

A WTRU may apply a candidate cell configuration. In some examples, the candidate cell application may fail. A WTRU may perform one or more of the following upon configuration failure of a candidate cell configuration (e.g., when attempting to apply the configuration): the WTRU may report the failure; the WTRU may release the configuration; the WTRU may keep the configuration; the WTRU may keep the configuration until the WTRU receives a subsequent RRC reconfiguration from the network; the WTRU may decide whether to keep or release the configuration based on any of these conditions; the WTRU may release a candidate cell configuration; the WTRU may release a candidate cell configuration to apply at L3 mobility, and/or at L1/L2 mobility; the WTRU may be configured with rules as to whether or not to release a candidate cell RRC configuration in case of failure to apply the configuration. Additionally or alternatively, a WTRU may release a configuration upon failure (e.g., as long as the candidate cell is not the identified anchor cell). The report failure may be made immediately, and/or at a subsequent event trigger, and/or upon satisfying a condition (e.g., as described herein).

The WTRU may attempt to add another candidate cell to the PLMT list and/or attempt to apply another cell configuration. For example, the WTRU may attempt to add another cell configuration if the WTRU finds another candidate cell. For example, the other candidate cell may meet criteria for being added as a PLMT cell. In some examples, the WTRU may avoid and/or delay reporting the failure. For example, the WTRU may avoid and/or delay reporting the failure, if applying the configuration is successful. Alternatively, or additionally, (e.g. in the case the WTRU is unable to find another configuration that meets the criteria, and/or all subsequent selected candidate cells also result in configuration error), the WTRU may report the failure.

A WTRU may report a candidate cell RRC reconfiguration failure. For example, a candidate cell RRC reconfiguration failure may be reported via RRC message (e.g. UEAssistanceInformation) transmitted by the WTRU. The RRC reconfiguration failure report may include one or more of the following information (e.g., which may be associated with each of the one or more candidate cell(s) for which RRC reconfiguration failure is reported): the identity of the cell (e.g. cell ID) for each candidate cell; an index assigned to the candidate cell RRC reconfiguration (e.g., when an index is provided to the WTRU); the identity of the cell (e.g. cell ID) from which the WTRU initially received the configuration of the candidate cell; the identity of the cell (e.g. cell ID) acting as the anchor cell (e.g., as described herein) for an SCell; and/or RRM measurements for one or more other candidate cell(s) and/or the candidate cell(s) that have a failed reconfiguration.

A WTRU may maintain identification of an anchor cell. For example, the identification of the anchor cell may be maintained for applying a candidate cell configuration and/or L3 mobility. A WTRU may maintain the identity of an anchor cell. For example, the WTRU may maintain the identity of an anchor cell for each SCell. In some examples, the WTRU may maintain the identity of an anchor cell in order to apply different stored cell configurations at the WTRU during L1/L2 mobility. The anchor cell may be configured via a delta RRC configuration. The candidate cell may have a delta configuration. For example, a WTRU may receive one or more candidate cell configurations in the form of delta configuration. The WTRU may determine a full cell configuration. The WTRU may determine the full cell configuration by applying the delta configuration to an existing configuration. Additionally, or alternatively, the WTRU may apply the delta configuration to the existing configuration on the anchor cell. For example, a WTRU may determine a full cell configuration by applying that cell configuration (e.g., obtained using delta signaling) to the anchor cell configuration associated with an SCell. In some examples, a WTRU may apply the RRC configuration for the target cell to the anchor cell at the time of the HO/CHO/conditional PSCell addition or change (CPAC). For example, during a HO/CHO/CPAC to a target cell from an SCell, a WTRU may apply the RRC configuration for the target cell to the anchor cell at the time of the HO/CHO/CPAC, and/or not to the SCell configuration that is the source of the mobility. A WTRU may change an SCell from a source cell to a target cell (e.g., where the target cell is one of the candidate cells for L1/L2 mobility). For example, the WTRU may change an SCell from a source cell to a target cell without changing the anchor cell. In some examples, the WTRU may change an SCell from a source cell to a target cell during L1/L2 mobility.

A network may control/initiate an anchor cell change. In some examples, an anchor cell change may be performed by the network via RRC signaling. For example, a WTRU may receive an RRC message on a serving cell. The RRC message may indicate that the WTRU is to change of the anchor cell for that serving cell. The RRC message may contain the cell ID of a cell to be the new anchor cell. The WTRU may receive a cell index associated with the candidate cells to identify the new anchor cell.

A WTRU may change the reference cell configuration for one or more (e.g., all) future mobility commands and/or configurations of new candidate cells. In some examples, the WTRU may change the reference cell configuration for one or more (e.g., all) future mobility commands and/or configurations of new candidate cells based on a network controlled anchor cell change. For example, upon reception of an L3 mobility (HO/CHO/CPAC), the WTRU may apply one or more delta configurations. Also, or alternatively, the WTRU may apply one or more delta configuration upon receiving a new candidate cell with/after a network controlled anchor cell change. The one or more delta configurations may be applied on top of the new anchor cell's configuration (e.g., which may be indicated in the anchor cell change).

A WTRU may receive candidate cell configurations and/or conditional handover commands. For example, the WTRU may receive candidate cell configurations and/or conditional handover commands along with a network controlled anchor cell change. In some examples, the WTRU may determine the target cell configuration for the candidate cell and/or CHO candidate. For example, the WTRU may determine the target cell configuration for the candidate cell and/or CHO candidate based on the new anchor cell in the anchor cell change.

In certain scenarios, a WTRU may fail an anchor cell change. For example, a WTRU may fail an anchor cell change due to one or more of the following: the WTRU attempts to apply the configuration of the anchor cell and the configuration fails; the cell ID and/or index indicated in the anchor cell change is not a serving cell or a stored/configured candidate cell; and/or the WTRU is asked to add a candidate cell as a PLMT cell in the anchor cell change and the configuration fails.

A WTRU may maintain the current anchor cell, maintain operation on the current serving cell change, and/or ignore any CHO candidates and/or candidate cells included in the anchor cell change. For example, a WTRU, upon a failure during an anchor cell change may maintain the current anchor cell, maintain operation on the current serving cell change, and/or ignore any CHO candidates and/or candidate cells included in the anchor cell change.

A WTRU, upon successful anchor cell change may perform one or more of the following: release one or more (e.g., all) candidate cells stored at the moment of reception of the anchor cell change; release one or more (e.g., all) candidate cells stored at the moment of reception of the anchor cell change which are not currently PLMT cells; release one or more (e.g., all) candidate cells stored at the moment of reception of the anchor cell change whose configuration were not applied and/or were not (e.g., never) PLMT cells, (e.g., from the time of the last L3 mobility) and/or the time of the last anchor cell change); and/or report certain information associated with candidate cells (e.g., in a confirmation RRC message). For example, the information associated with candidate cells that is reported by the WTRU may include one more of: the candidate cells that were released by the WTRU, the candidate cells that were maintained by the WTRU, the candidate cells that are PLMT cells and/or cells with applied configuration that were released and/or maintained, or L3 measurements of any of the candidate cells. Alternatively, or additionally, the WTRU may release one or more candidate cells. As described herein, the information associated with candidate cells may be reported by the WTRU via a bitmap.

A WTRU may be configured to perform a conditional anchor cell change. For example, the WTRU may trigger an anchor cell change, and/or inform the network of such. The WTRU may base the trigger of the anchor cell change on the occurrence of one or more conditions. The WTRU may be configured with one or more measurement events (e.g., similar to CHO to perform conditional anchor cell change). The one or more measurement events may be related to the current anchor cells, the current serving cell, and/or any of the candidate serving cells. The WTRU may be configured with a new/updated set of events for conditional anchor cell change. For example, the new/updated set of events may be based on any of the events described for adding a PLMT cell.

A WTRU may be configured to maintain a PLMT list and/or utilize the PLMT list to facilitate L1/L2 mobility procedures. For example, the WTRU may be configured with one or more events/triggers for adding/removing a candidate cell from the list of PLMT cells. A WTRU may be configured with one or more conditions for applying a configuration of a stored candidate cell and/or adding a stored/configured candidate cell as a PLMT cell. For example, the one or more conditions for applying a configuration of a stored candidate cell and/or adding a stored/configured candidate cell as a PLMT cell may be based on one or more measurement events. For example, for each candidate cell, the WTRU may be configured with a condition for applying the configuration of the candidate cell and/or adding the candidate cell as a PLMT cell. In some scenarios, a condition for applying a configuration of a stored candidate cell and/or adding a stored/configured candidate cell as a PLMT cell may be associated with L3 measurements of the candidate cell. For example, a condition may be associated with measurements relative to a serving cell. Alternatively, or additionally, a condition for applying a configuration of a stored candidate cell and/or adding a stored/configured candidate cell as a PLMT cell may be one of the conditions described herein.

A WTRU may be configured with a condition (e.g., a single condition) for a serving cell, and/or a condition (e.g., a single condition) for one or more (e.g., a set or all) candidate cells associated with a serving cell. For example (e.g., when configured with a set of candidate cells), the WTRU may receive a condition for adding one or more of the candidate cells to the list of candidate cells. In some examples, the one or more candidate cell configuration(s) may be applied and/or added as a PLMT. An event may be based on one or more legacy L3 measurement event(s). For example, one or more L3 event(s) may be related to the serving cell and/or the list of candidate cells. In some examples, events may include one or more of the following: the serving cell quality falls below a threshold, the candidate cell quality exceeds a serving cell quality threshold, the candidate cell quality exceeds a threshold, or any combination thereof.

A WTRU may be configured with a condition for removing a candidate cell as a PLMT cell per candidate, per serving cell, and/or per a set of (e.g., all) candidates.

In certain scenarios, the condition for removing a candidate cell as a PLMT cell per candidate, per serving cell, and/or per a set of (e.g., all) candidates may be related to one or more L3 measurements. For example, the condition may include one or more of the following: the serving cell exceeds than a threshold, the candidate cell quality does not exceed a threshold, the candidate cell quality does not exceed a serving cell quality threshold, or any combination thereof.

A WTRU may apply L3 measurement events. For example a WTRU may apply L3 measurement events by comparing one or more candidate non-PLMT cells with one or more candidate PLMT cells. In another scenario, the WTRU may apply L3 measurement events by comparing one or more candidate PLMT cells. In another example, the WTRU may apply L3 measurement events by comparing one or more candidate non-PLMT cells. In some examples, an event may be a new event type. For example, an event may be defined for the RRM measurements between one or more (e.g., multiple) cells.

A3-like events may involve multiple cells. An A3-like event may compare a neighbor cell to a serving cell. Alternatively, or additionally, the A3-like event may trigger an event when the neighbor cell exceeds a threshold and/or exceeds a value associated with the serving cell. For example, a WTRU may add a candidate cell to the list of PLMT cells. In some examples, a WTRU may add a candidate cell to the list of PLMT cells if the candidate cell is a threshold better than all current PLMT cells. In some examples, a WTRU may add a candidate cell as a PLMT cell if the candidate is a threshold better than the best current PLMT cell. For example, a WTRU may add a candidate cell as a PLMT cell if the candidate cell is a threshold better than at least X (e.g., a configured number) current PLMT cell(s). For example, a WTRU can add a candidate cell as a PLMT cell if the candidate cell is a threshold better than the average of the current PLMT cells. In some examples, similar A3-like events as herein may be defined for a removal of a current PLMT cell.

A5-like events may involve multiple cells. An A5-like event may compare a neighbor cell to a threshold. Additionally, or alternatively, the A5-like event may compare a serving cell to a threshold (e.g., a different threshold). For example, a WTRU may replace a PLMT cell with a candidate non-PLMT cell. In some examples, the WTRU may replace a PLMT cell with a candidate non-PLMT cell if, for example, the PLMT cell does not exceed a threshold and/or the non-PLMT cell exceeds a threshold. For example, a WTRU may replace a PLMT cell with a candidate non-PLMT cell if at least X (e.g., a configured number) PLMT cells do not exceed a threshold and/or at least Y (e.g., a configured number) non-PLMT candidate cells exceed a threshold. X and Y may be configured and/or may be predefined with the event in some examples. Similar A5-like events as herein can be defined for a removal of a current PLMT cell.

In some scenarios, the WTRU may be configured with events and/or conditions for adding a candidate cell to the list of PLMT cells and/or removing a candidate cell from the list of PLMT cells.

The WTRU may consider various conditions to determine the number of PLMT cells for a serving cell. For example, a WTRU can be configured with a maximum/minimum number of PLMT cells. In some scenarios, the WTRU may ensure (e.g., based on other conditions) that the number of PLMT cells does not exceed the maximum and/or is not smaller than the minimum. In some scenarios, a WTRU may determine the number of PLMT cells based on a WTRU capability. For example, the total number of PLMT cells (e.g., over a cell group, per serving cell, etc.) should not exceed the WTRU capability. In another example, the total number of configured cells (e.g., potentially over a cell group, frequency, band, etc.) should not exceed the WTRU capability. For example, the total number of serving cells and PLMT cells (e.g., over a cell group, frequency, band, etc.) should not exceed the WTRU capability. In some scenarios, the WTRU may be configured per serving cell.

In certain scenarios, a WTRU may determine the number of PLMT cells. For example, the WTRU may determine the number of PLMT cells for a serving cell, based on a data rate. In some scenarios, the number of PLMT cells maintained by the WTRU may be a function of the data rate at the WTRU (e.g., computed over all bearers) and/or a function of buffer occupancy at the WTRU.

A WTRU may determine the number of PLMT cells, for example for a serving cell, based on mobility criteria. For example, the number of PLMT cells maintained by the WTRU may be a function of the WTRU's speed. In some scenarios, the number of PLMT cells maintained by the WTRU may be a function of the number of mobility events (e.g. L3 mobility and/or L1/L2 mobility) performed at the WTRU over a period of time. For example, the period of time may be a recent period of time.

A WTRU may determine the number of PLMT cells, for example for a serving cell, based on frequency range/band. In some scenarios, the WTRU may be configured with a number of PLMT cells to maintain for a specific frequency/band. For example, the specific frequency/band may be associated with the serving cell(s).

In certain scenarios, a WTRU may determine the number of PLMT cells, for example for a serving cell, based on the beam characteristics. For example, the WTRU may be configured with a number of PLMT cells to maintain. The number of PLMT cells to maintain may be related to a beam width, a number of beams. Additionally or alternatively, the number of PLMT cells to maintain may be related to any characteristic of the beams associated with either the serving cell(s), the PLMT cell(s), and/or a combination thereof.

A WTRU may determine the number of PLMT cells, for example for a serving cell, based on the numerology. In some scenarios, the WTRU may be configured with a number of PLMT cells to maintain based on the numerology configured for the serving cell, PLMT cells, candidate cells, and/or a combination thereof.

In some scenarios, a WTRU may determine the number of PLMT cells, for example for a serving cell, based on L1/L2 and/or L3 measurements. In some examples, the WTRU may be configured with a number of PLMT cells that are determined based on the L3 measurements of the serving cell and/or L3 measurements of the candidate and/or PLMT cells. In some scenarios, the WTRU may be configured to maintain a PLMT cell as long as the cell satisfies some L3 measurement criteria.

A WTRU may determine the number of PLMT cells, for example for a serving cell, based on the number of candidate cells configured for the serving cell. In some examples, a WTRU may be configured with a set of one or more candidate cells for each serving cell. In certain scenarios, the number of PLMT cells maintained while served by a serving cell may be a function (e.g. a ratio) of the number of candidate cells configured for the serving cell.

In certain scenarios, a WTRU may determine the number of PLMT cells, for example for a serving cell, based on conditions/triggers for beam failure detection/recovery. For example, a WTRU may remote/replace a PLMT cell with another candidate cell when the WTRU detects beam failure on a beam. In some scenarios, the beam may be the best beam and/or a configured number of beams associated with the cell. The WTRU may perform removal/replacement immediately and/or following a configured time period. For example, a WTRU may add a candidate cell as a PLMT cell if the WTRU performs successful beam failure recovery to a beam which belongs to a candidate cell.

A WTRU may be configured to add a candidate cell as a PLMT cell and/or remove a candidate cell as a PLMT cell based on conditions/triggers related to time. For example, a WTRU may add a candidate cell as a PLMT cell, and/or remote a cell as a PLMT cell if, for example, any condition herein is satisfied for that PLMT cell for at least a configured time period.

A WTRU may be configured to add a candidate cell as a PLMT cell and/or remove a candidate cell as a PLMT cell based on conditions/triggers related to position. For example, a WTRU may be configured with a position to associate to each cell (e.g., in the candidate cell configuration). In some scenarios, the WTRU may add a candidate cell as a PLMT cell if the WTRU's position is within X (e.g., a configured number) meters of the position configured for the cell. In some examples, a WTRU may remove a PLMT cell if the WTRU's position is further than Y (e.g., a configured number) meters from the position configured for the cell.

A WTRU may be configured to add a candidate cell as a PLMT cell and/or remove a candidate cell as a PLMT cell based on conditions/triggers related to a change in cell quality. For example, a WTRU may remove a PLMT cell if the cell quality drops by more than a certain amount (e.g., a configured number) in a configured period of time.

A WTRU may be configured to add a candidate cell as a PLMT cell and/or remove a candidate cell as a PLMT cell based on conditions/triggers. For example, the conditions/triggers may be based on L1/L2 mobility and/or L3 mobility/reconfiguration. In some scenarios, a WTRU may determine a new set of the list of PLMT cells due to reconfiguration of the candidate cells. The WTRU may determine the new set of the list of PLMT cells following L1 mobility, for example. In some examples, if a PLMT cell is removed due to the removal of one or more candidate cell in the WTRU's stored candidate cell configurations, the WTRU may select a new PLMT cell to replace the removed cell.

A WTRU may be configured to add a candidate cell as a PLMT cell and/or remove a candidate cell as a PLMT cell based on conditions/triggers based on, for example, cell activation/deactivation and/or dormancy. For example, the WTRU may add/remove a PLMT cell associated with a serving cell based on one or more of the following (e.g., to meet the WTRU capabilities): serving cell addition/removal, cell activation/deactivation, a cell is moved into/out of dormancy, and/or any combination thereof.

In some scenarios, based on the triggers/conditions described herein, a number (e.g., a larger number) of cells may meet certain criteria for addition/removal than what is allowed. For example, the number of cells that are allowed to be added/removed may be based on other criteria (e.g. maximum number), which may be configured. The WTRU may select one or more cells to add/remove. In scenarios where the maximum number is exceeded, for example, the WTRU may use other conditions described herein to determine the specific cells to add/remove. For example, the WTRU may select the cells with the best/worst RRM measurements and/or position to add/remove.

A WTRU may initiate L1/L2 mobility upon reception of network signaling (e.g., DCI on the serving cell). In some scenarios, signaling may consist of an explicit indication to perform cell mobility (e.g., implicitly/explicitly contains an identity of the cell). The WTRU may select the best beam on the target cell to perform communication following the reception of the DCI. Alternatively, or additionally, signaling may be a DCI that indicates a change in beam/TCI state. For example, the beam/TCI state may indicate a beam and/or TCI state configuration associated with a neighbor cell. In some scenarios, the WTRU may determine whether the beam indicated in the DCI is associated with the serving cell and/or one of the PLMT cells. For example, upon reception of DCI, the WTRU may determine whether the beam indicated in the DCI is associated with the serving cell and/or one of the PLMT cells. In some examples, the WTRU may initiate the actions associated with L1/L2 mobility. For example, the WTRU may initiate any action herein associated with L1/L2 mobility if associated with a PLMT cell. Alternatively, or additionally, the WTRU may receive a MAC CE which triggers the L1/L2 mobility. For example, the WTRU may receive a MAC CE which activates one or more TCI states associated with a different cell. The WTRU may determine L1/L2 mobility implicitly and/or explicitly from the contents of the MAC CE (e.g. the cell identity, or the identity of the TCI state configuration). In some scenarios, if the MAC CE indicates activation of a TCI state associated with a different cell, the WTRU may trigger L1/L2 mobility. Furthermore, combinations of the above may also trigger L1/L2 mobility.

In certain scenarios, upon triggering L1/L2 mobility for example, a WTRU may perform one or more of the following actions in any order. The WTRU may send acknowledgement to the source cell before or after successful completion of the L1/L2 mobility. For example, the WTRU may send acknowledgement to the source cell (e.g. in response to the trigger, which may be from a DL allocation). The WTRU may send the acknowledgement following a successful reception and/or transmission on the target cell. The WTRU may stop monitoring PDCCH of the source cell. For example, the WTRU may stop monitoring PDCCH of the source cell upon triggering L1/L2 mobility. The WTRU may initiate RACH to the target cell or UL transmission to the target cell. For example, the WTRU may initiate RACH to the target cell or UL transmission to the target cell upon triggering L1/L2 mobility. In some scenarios, the WTRU may perform either a 2-step RACH or a 4-step RACH procedure. For example, the WTRU may perform the 2-step or the 4-step RACH procedure based on whether the target cell is UL synchronized with the source cell, whether the L1/L2 mobility was triggered by DCI or by MAC CE from the source cell, and/or whether the WTRU had a pending UL grant at the time the L1/L2 mobility was triggered, and/or any combination thereof.

A WTRU may apply any non-applied part or parts of the target cell RRC configuration (e.g., as described above). For example, the WTRU may apply any non-applied part or parts upon triggering L1/L2 mobility. The WTRU may apply the RRC configuration, for example, after the WTRU has successfully performed transmission/reception to the target cell. In some scenarios, the WTRU may revert back to the source cell configuration and/or trigger RACH transmission to the source cell in case of failure of the L1/L2 mobility. For example, upon triggering L1/L2 mobility, the WTRU may revert back to the source cell configuration and/or trigger RACH transmission to the source cell in case of failure of the L1/L2 mobility. The WTRU may fail L1/L2 mobility if, for example, the WTRU detects beam failure prior to any successful DL/UL transmission with the target cell, and/or the WTRU fails to receive DL transmissions from the target cell after a period of time, and/or a number of attempts (e.g., of the RACH procedure).

In some scenarios, the WTRU may add the source cell as a PLMT cell, for example, at least for a period of time. The WTRU may add the source cell as a PLMT cell upon success of the L1/L2 mobility. In some embodiments, the WTRU may be configured with a period of time for which the source cell should be a PLMT cell, and/or may maintain the source cell as a PLMT cell for at least that period of time. For example, the WTRU may perform beam management as described herein for at least that period of time for the source cell (e.g., following mobility). The WTRU may perform one or more of removing the new serving cell from the set of configured candidate cells, applying the stored RRC configuration for the candidate cells (e.g., and L1/L2 mobility parameters) associated with the new serving cell, determining a new set of the list of PLMT cells from the new/updated candidate cells and associated L1/L2 mobility parameters, and releasing the configuration of any cell remoted from the list of PLMT cells, or any combination thereof. For example, upon success of L1/L2 mobility, the WTRU may perform one or more of removing the new serving cell from the set of configured candidate cells, applying the stored RRC configuration for the candidate cells (e.g., and L1/L2 mobility parameters) associated with the new serving cell, determining a new set of the list of PLMT cells from the new/updated candidate cells and associated L1/L2 mobility parameters, and releasing the configuration of any cell remoted from the list of PLMT cells, or any combination thereof.

A WTRU may be configured to perform beam management on one or more PLMT Cells. In some scenarios, the WTRU may be configured to perform a modified form of beam management on a PLMT cell. For example, modified beam management may include one or more of the following: performing beam measurements on the PLMT cell, report beam measurements on the serving cell, performing/reporting beam measurements with a reduced or different periodicity, performing/reporting beam measurements without triggering beam failure detection and/or recovery, performing beam failure detection/reporting without any recovery actions, performing a modified beam failure detection procedure as described herein, or any combination thereof.

A WTRU may perform beam failure detection and/or trigger indication of beam failure to the network for certain PLMT cells (e.g., for RLM/RLF). For example, a WTRU may use the same/similar conditions for performing beam failure detection as for performing RLM. In some scenarios, the WTRU may use the same conditions for reporting beam failure as for reporting RLF.

In some scenarios, a WTRU may perform beam failure and/or a trigger indication for one or more cells. For example, the WTRU may be configured with a condition based on whether beam failure is detected/reported for a PLMT cell. For example, the WTRU may report beam failure for a cell which has RSRP above a threshold. For example, the WTRU may report beam failure for a cell whose indicated position has a specific distance from the WTRU's position. For example, the WTRU may report beam failure only for a subset of the candidate cells for a given serving cell, as configured by the network. In some scenarios, the WTRU may determine the subset of candidate serving cells based on the configured measurement criteria, WTRU capabilities, and/or the number of configured serving cells being utilized by the WTRU. For example, the subset of neighbor cells may be selected to be all candidate cells that are determined to have RSRP above a threshold (e.g., assuming the number of candidates that meet the criteria do not exceed the processing capabilities of the WTRU). In some examples, the criteria may include a reference signal received power (RSRP) and/or a RSRP threshold. For example, if the criteria includes a RSRP threshold, the subset of the plurality of candidate cells may include the candidate cells (e.g., all the candidate cells) that are associated with a RSRP measurement that is above the RSRP threshold. The measurement criteria may include channel state information-reference signal received power (CSI-RSRP). Alternatively, or additionally, the measurement criteria may include synchronization signal block-reference signal received power (SSB-RSRP). In some scenarios, determining the subset of a plurality of candidate cells may be at least partially based on a number of configured candidate cells. For example, the number of configured candidate cells may be greater than a threshold.

A beam failure indication (e.g., a MAC CE) may be reported to the serving cell in some scenarios. for example, the WTRU may report the cell or cells on which beam failure was detected along with the beam failure report. The MAC CE may contain one or more cell IDs and/or indices (e.g., associated with a PLMT cell) in which beam failure was triggered. In some examples, the report may include a bitmap. The bitmap may be included in a MAC CE. The indication to perform handover may be received in downlink control information (DCI). In some examples, the report may be sent to and/or received from a base station. The WTRU may report to a network upon a change to one or more of the candidate cells among the subset of a plurality of candidate cells in some scenarios.

The WTRU may be configured to receive and/or transmit configuration information. For example, the configuration information may be associated with one or more candidate cells. In some examples, the configuration information may include one or more of a physical layer measurement and measurement criteria. The measurement criteria may, for example, include RSRP exceeding a threshold. In some scenarios, the WTRU may be configured to perform one or more physical layer measurements on the subset of a plurality of candidate cells. For example, the one or more physical layer measurements may be associated with configuration information. In some embodiments the one or more physical layer measurements may include one or more of radio link monitoring and beam measurement. In some examples, the WTRU may be configured to perform the one or more measurements on one or more of the candidate cells. The subset of one or more plurality of candidate cells may include one or more candidate cells above a RSRP threshold.

The WTRU may be configured to determine a subset of one or more candidate cells. For example, the WTRU may determine the one or more candidate cells in the subset based on measurement criteria. In some examples, the WTRU may be configured to send and/or receive a report that indicates the subset of the one or more candidate cells. For example, the report may include a bitmap. In some scenarios, the report may be sent and/or received via MAC CE.

The WTRU may be configured to receive an indication to perform a handover. The handover may be a lower layer handover, for example (e.g., L1/L2 mobility). For example, lower layer handover may be associated with a lower latency (e.g., as compared to other handover techniques). The WTRU may be configured with an RRC configuration. The RRC configuration may be synchronized to the target cell (e.g., for lower layer handover). The lower layer handover may be performed to one or more candidate cells of the subset of the plurality of candidate cells. In some scenarios, a candidate cell may be maintained as a candidate cell in the plurality of candidate cells for a predetermined period. The predetermined period may be measured from receipt of the indication to perform handover. In some embodiments, handover may be initiated after one or more of a beam failure or a failed beam failure recovery. In some examples, the indication may be received and/or sent via one or more of MAC CE and DCI. The WTRU may be configured to maintain one or more candidate cell configurations after receipt of the indication to perform handover.

A WTRU may be configured with conditions for whether and/or when to perform beam failure reporting to the network. For example, the WTRU may use the conditions to determine whether and/or when to perform beam failure reporting to the network following a beam failure detection. In some scenarios, the conditions for whether and/or when to perform beam failure reporting to the network may be similar to those associated with adding a cell as a PLMT cell. For example, a WTRU may delay reporting of a beam failure detected on a PLMT cell until a later time when a specific condition described herein is satisfied. For example, a WTRU may delay reporting of beam failure detected on a PLMT cell until the number of PLMT cells with/without beam failure reaches a threshold. Alternatively, or additionally, the WTRU may delay beam failure recovery until L1/L2 mobility is triggered to the cell. For example, the WTRU, upon detection of beam failure on a PLMT cell, may leave the beam failure pending for the PLMT cell. If the WTRU triggers L1/L2 mobility to that cell and the beam failure is still pending, the WTRU may initiate a beam failure recovery-like procedure (e.g., RACH to a different beam) upon L1/L2 mobility. A WTRU may report a pending beam failure upon L1/L2 mobility to the target cell, if, for example, the beam failure occurred on a PLMT cell other than the target cell of the mobility.

In some scenarios, a WTRU may maintain a detected beam failure pending for a certain period of time. For example, a WTRU may detect the beam failure, but not report the beam failure for the period of time. When the period of time expires and the conditions for reporting beam failure have not been met, the WTRU may cancel the pending beam failure report associated with one or more PLMT cells in some scenarios.

In an example embodiment, a WTRU may trigger L1/L2 mobility as a result of beam failure on a serving cell. In one example, following beam failure detection on the serving cell, if the WTRU determines that a beam on a PLMT cell is better than any beam associated with the serving cell, for example by a threshold amount, the WTRU may trigger L1/L2 mobility to that cell. In another example, if a WTRU triggers beam failure recovery on the serving cell, and beam failure recovery is unsuccessful, the WTRU may initiate L1/L2 mobility to an PLMT cell. In some scenarios, the WTRU may initiate L1/L2 mobility if a PLMT cell is found that satisfies any condition herein.

In some scenarios, a WTRU that triggers L1/L2 mobility due to failure to recover from beam failure may initiate re-establishment (e.g., rather than perform any of the recovery actions described herein for L1/L2 mobility failure). For example, following failed L1/L2 mobility the WTRU that triggers L1/L2 mobility due to failure to recover from beam failure may initiate re-establishment. A WTRU that triggers L1/L2 mobility due to beam failure on a serving cell may report beam failure to the target of the L1/L2 mobility (e.g. using a MAC CE) in some scenarios. For example, a WTRU may trigger L1/L2 mobility to a PLMT cell which does not have a beam failure pending, and/or for which the BFI counter meets a certain criteria.

A WTRU may maintain the beam failure context (e.g., BFI counter, BFR timer) of a PLMT cell. For example, the WTRU may maintain the beam failure context of a PLMT cell when the WTRU performs L1/L2 mobility to that cell. Alternatively, or additionally, the WTRU may keep only some portions of the context (e.g. the WTRU may reset the timer but not reset the counter). Alternatively, or additionally, the WTRU may reset the entire context for the cell. Alternatively, or additionally, the WTRU may modify the context, such as, for example, subtract a configured value from the counter/timer.

In some embodiments, a WTRU may maintain a single beam failure context (e.g. BFI, counter, etc.) for configured PLMT cells (e.g., all configured PLMT cells). For example, the WTRU may increment a (e.g., a single BFI) counter if the WTRU receive beam failure indication from the PHY layer associated to any of the PLMT cells in the list of PLMT cells. Alternatively, or additionally, the WTRU may increment a BFI counter. For example, the WTRU may increment a BFI counter if it receives beam failure indication from at least N (e.g., a configured number) of the PLMT cells in the list of PLMT cells.

The processes described herein may be implemented in a computer program, software, and/or firmware incorporated in a computer-readable medium for execution by a computer and/or processor. Examples of computer-readable media include, but are not limited to, electronic signals (e.g., transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, WTRU, terminal, base station, RNC, and/or any host computer.

What is claimed is:

1-15. (canceled)

16. A wireless transmit/receive unit (WTRU) comprising:
a processor configured to:
receive radio resource control (RRC) configuration information, wherein the RRC configuration information comprises an indication of a plurality of candidate cells, delta configurations for at least a subset of the plurality of candidate cells, and an anchor RRC configuration;
receive a medium access control (MAC) control element (CE) that indicates that the WTRU should perform a handover to a candidate cell of the plurality of candidate cells, wherein RRC configuration information comprises a delta configuration for the candidate cell;
determine RRC parameters for the candidate cell based on the anchor RRC configuration and the delta configuration for the candidate cell;
perform a handover to the candidate cell based on the RRC parameters; and
maintain the anchor RRC configuration and the delta configurations for at least a subset of the plurality of candidate cells after handover to the candidate cell is complete.

17. The WTRU of claim 16, wherein the RRC configuration information and the MAC CE are received from a serving cell, and wherein the processor is further configured to:
release RRC parameters for a serving cell of the WTRU prior to performing handover to the candidate cell.

18. The WTRU of claim 16, wherein the RRC configuration information and the MAC CE are received from a serving cell, and wherein the determined RRC parameters are not RRC parameters used with the serving cell.

19. The WTRU of claim 16, wherein the processor is configured to:
apply the delta configuration for the candidate cell to the anchor RRC configuration to determine RRC parameters for the candidate cell.

20. The WTRU of claim 19, wherein handover to the candidate cell is further based on condition that the delta configuration for the candidate cell is applied to the anchor RRC configuration.

21. The WTRU of claim 16, wherein the processor is configured to:
perform measurements for each of the plurality of candidate cells; and
send one or more reports that indicate the measurements of each of the plurality of candidate cells.

22. A method performed by a wireless transmit/receive unit (WTRU), the method comprising:
receiving radio resource control (RRC) configuration information, wherein the RRC configuration information comprises an indication of a plurality of candidate cells, delta configurations for at least a subset of the plurality of candidate cells, and an anchor RRC configuration;
receiving a medium access control (MAC) control element (CE) that indicates that the WTRU should perform a handover to a candidate cell of the plurality of candidate cells, wherein RRC configuration information comprises a delta configuration for the candidate cell;
determining RRC parameters for the candidate cell based on the anchor RRC configuration and the delta configuration for the candidate cell;
performing a handover to the candidate cell based on the RRC parameters; and
maintaining the anchor RRC configuration and the delta configurations for at least a subset of the plurality of candidate cells after handover to the candidate cell is complete.

23. The method of claim 22, wherein the RRC configuration information and the MAC CE are received from a serving cell, and wherein the method further comprises:
releasing RRC parameters for a serving cell of the WTRU prior to performing handover to the candidate cell.

24. The method of claim 22, wherein the RRC configuration information and the MAC CE are received from a serving cell, and wherein the determined RRC parameters are not RRC parameters used with the serving cell.

25. The method of claim 22, further comprising applying the delta configuration for the candidate cell to the anchor RRC configuration to determine RRC parameters for the candidate cell.

26. The method of claim 25, wherein handover to the candidate cell is further based on condition that the delta configuration for the candidate cell is applied to the anchor RRC configuration.

27. The method of claim 22, further comprising
performing measurements for each of the plurality of candidate cells; and
sending one or more reports that indicate the measurements of each of the plurality of candidate cells.

28. A method performed by a wireless transmit/receive unit (WTRU), the method comprising:
receiving radio resource control (RRC) configuration information, wherein the RRC configuration information comprises an indication of a plurality of candidate cells, delta configurations for at least a subset of the plurality of candidate cells, and an anchor RRC configuration;
receiving a first medium access control (MAC) control element (CE) that indicates that the WTRU should perform a handover to a first candidate cell of the plurality of candidate cells, wherein RRC configuration information comprises a delta configuration for the first candidate cell;
determining first RRC parameters for the first candidate cell based on the anchor RRC configuration and the delta configuration for the first candidate cell;
performing handover to the first candidate cell based on the first RRC parameters and the delta configuration for the first candidate cell;
receiving a second MAC CE that indicates that the WTRU should perform a handover to a second candidate cell of the plurality of candidate cells;
determining second RRC parameters for the second candidate cell based on the anchor RRC configuration; and
performing handover to the second candidate cell based on the second RRC parameters.

29. The method of claim 28, further comprising maintaining the anchor RRC configuration and the delta configurations for at least a subset of the plurality of candidate cells after handover to the first candidate cell is complete.

30. The method of claim 29, further comprising maintaining the anchor RRC configuration and the delta configurations for at least a subset of the plurality of candidate cells after handover to the second candidate cell is complete.

31. The method of claim 28, wherein the RRC configuration information and the MAC CE are received from a serving cell, and wherein the method further comprises:
releasing RRC parameters for a serving cell of the WTRU prior to performing handover to the first candidate cell.

32. The method of claim 28, wherein the RRC configuration information and the MAC CE are received from a serving cell, and wherein the determined first RRC parameters and second RRC parameters are not RRC parameters used with the serving cell.

33. The method of claim 28, further comprising applying the delta configuration for the first candidate cell to the anchor RRC configuration to determine the first RRC parameters for the first candidate cell.

34. The method of claim 33, wherein handover to the first candidate cell is further based on condition that the delta configuration for the first candidate cell is applied to the anchor RRC configuration.

35. The method of claim 28, wherein the RRC configuration information does not comprise a delta configuration for the second candidate cell.
